(19) United States
(12) Patent Application Publication
(10) Pub. No.: US 2026/0049489 A1
(43) Pub. Date: Feb. 19, 2026

(54) FALL IMPACT PROTECTION SYSTEM

(71) Applicant: Brent Davis, Gilbert, AZ (US)

(72) Inventor: Brent Davis, Gilbert, AZ (US)

(21) Appl. No.: 19/369,924

(22) Filed: Oct. 27, 2025

Related U.S. Application Data
(63) Continuation-in-part of application No. 17/368,797, filed on Jul. 6, 2021.

(51) Int. Cl. E04G 21/32; B64F 1/36

(52) U.S. Cl. CPC E04G 21/3271; B64F 1/36

(57) ABSTRACT

A grounded and modular fall impact protection airbag system designed to absorb the kinetic energy of objects or persons falling from high elevations in such a manner that concurrently cushions impact while minimizing the transfer of elastic potential energy that can result in a rebound event. In this manner, the potential for damage or injury is minimized in both the impact and rebound kinetic energy transfer events. In contrast to existing grounded fall protection airbag systems that require continuous airflow from pneumatic devices to maintain optimal pressure before and after impact, this system implements air pressure relief valves that are actuated upon impact and release air pressure at a rate that safely decelerates the object or individual without a rebound effect. This allows for the system to be pressurized once per use, thus decreasing energy requirements and operational costs, improving system reliability, and increasing overall safety to the site.

### CROSS-REFERENCE TO RELATED APPLICATIONS

This patent application claims the benefit of priority to U.S. patent application Ser. No. 17/368,797, filed on Jul. 6, 2021 and entitled “FALL IMPACT PROTECTION SYSTEM”, which is hereby incorporated by reference in its entirety.

### FIELD OF THE INVENTION

The invention relates to fall impact protection systems for industries that require workers to operate with uninhibited mobility from great heights. Embodiments relate to a modular and interconnectable welded vinyl airbag system for creating a fall impact protection zone. A cap and valve may be used to permit air inflation while precluding depressurization. Pressure relief valves permit the depressurization of a particular airbag of the fall impact system that receives impact at a rate that safely decelerates the person or object that falls onto the particular airbag.

### BACKGROUND

The United States Department of Labor's Occupational Safety and Health Administration (OSHA), reported that in fiscal year 2018 fatal falls, slips, and trips accounted for 33% of fatal injuries in the construction industry and 16% of fatal events in all occupations combined. In the same year, fall protection violations constituted the largest category of cited OSHA standard violations. OSHA regulations require fall protection in industrial and maintenance settings when workers are exposed to fall hazards of 48 inches or higher. (29 CFR 1926.501, 29 CFR 1926.451, 29 CFR 1926.503). While such heights may appear to be inconsequential, significant injuries and deaths occur from such a height every year.

Certain positioning, suspension, and retrieval systems are available in the art. Positioning systems hold workers in place while leaving their hands free to allow work. They are activated every time the workers lean back. There is no fall arrest. Suspension systems lower and support workers while leaving hands free for activities to perform. Retrieval systems are used for rescue after a fall has occurred, which may not have a primary purpose in preventing the initial injury, but in the prevention of further harm or first steps in aiding the potentially injured.

Another category is fall arrest, which is primarily made from nets and lifelines. The fall arrest system comes into services when or if a fall occurs. Retractable lifelines, full body harnesses with shock absorbing lanyards are accepted as personal fall arrest systems. These systems may distribute forces throughout a worker's body, while shock-absorbing lanyards decrease total fall arresting forces. Body belts, chest harnesses, body harnesses, suspension belts, rope lanyards, web lanyards, cable lanyards, rope grabs, retractable lifelines, and safety nets are used in the industry. Shock absorbers reduce fall arresting forces and fall injury risks.

Aircraft fuselage and wing inspection and maintenance can be hazardous without proper safety equipment. OSHA, ANSI, and other organization-compliant fall equipment may use arrest anchors and horizontal lifelines to make the work environment on top and inside aircraft, inside and outside the hangar, safe and productive.

In light of the regulatory requirements, risks, and liabilities associated with falls, industrial employers are highly invested in establishing effective fall protection systems that meet and exceed regulatory requirements in a cost-effective manner while maximizing employee mobility and productivity. Fall protection is of importance in the construction, aviation, manufacturing, and entertainment industries (e.g., stunt fall protection) and also in the sports and recreation industries (e.g., gymnastics, amusement parks, and trampoline parks).

The state of the art in fall arrest and protection currently consists of deploying inflatable, high-strength vinyl airbags located on the ground surface in the area around the potential fall zone. Typically using a combination of netting and air bladders to decelerate and absorb the kinetic energy of the falling object or person, the prevailing method of maintaining sufficient air pressure requires the use of a continuous stream of air from a pneumatic device such as compressors or turbine systems. Such inflatable systems are known to be efficacious in fall protection, are relatively inexpensive, and are conveniently portable. However, the need to use a continuously operating pneumatic device places significant energy, ventilation, and other operational demands on the operator while increasing setup and breakdown times. Additionally, such systems are exposed to the risk of power interruption leading to depressurization and the potential for exhaust fumes to reach dangerous levels due to loss of ventilation.

The weakest component of the otherwise efficacious fall protection systems is their reliance upon continuous flow air pressurization and the constituent requirements for supporting said. It stands to reason that a technology that can remove such requirements would have great instrumental value in the evolution of the state of the art in the fall protection sector.

It is with respect to these and other considerations that the various aspects and embodiments of the present disclosure are presented.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In an implementation, a fall impact protection system is provided. The system includes: a plurality of airbags connected (e.g., buckled) together to create a fall impact protection zone, wherein each of the airbags is inflatable, and a trigger mechanism configured to release air pressure from at least one of the airbags when the at least one of the airbags is inflated and decelerate any kinetic force, responsive to an impact on the at least one of the airbags when inflated. The at least one of the airbags, when inflated, is configured to maintain pressurization prior to the impact without use of a continuous blower system.

In an implementation, a fall impact protection system is provided. The system includes: a plurality of bladders (each of which may be an air bag and/or comprised within an airbag), a plurality of valves, and a plurality of connectors between the bladders. Each of the valves comprises a fastener, a resilience device for storing elastic potential energy, and a valve plate that is configured to extrude in response to a predetermined amount of kinetic force to decelerate an impact. The at least one of the bladders, when inflated, is configured to maintain pressurization prior to the impact without use of a continuous blower system.

An object of the invention is to provide an inflatable fall impact protection system that absorbs the impact of a falling person or object in a manner that reduces the potential for damage, injury, or death. Another object of the invention is to remove the requirement of a continuous flow of air from pneumatic devices by creating a valve system that will only require one discrete inflation per use. Another object of the invention is to create a modular design that allows for multiple shape configurations while maintaining interconnectivity between inflation modules and consistent structural integrity across the customized system.

Other objects, features, and advantages of the invention will be readily apparent from the following detailed description of the preferred embodiment thereof taken in conjunction with the drawings.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1A shows a diagram of a perspective view of an implementation of a fall impact protection system in conjunction with an airplane;

FIG. 1B shows a diagram of a top view of the implementation of the fall impact protection system in conjunction with the airplane of FIG. 1A;

FIG. 1C shows a diagram of a side view (a rear view, horizontal depiction) of the implementation of the fall impact protection system in conjunction with the airplane of FIG. 1A;

FIG. 2A shows a diagram of a top view of an implementation of a rectangular shaped airbag with an air valve, pressure relief valves, and connectors;

FIG. 2B shows a diagram of a side view of the implementation of FIG. 2A;

FIG. 2C shows a diagram of a top view of an implementation of a triangular shaped airbag with an air valve, pressure relief valves, and connectors;

FIG. 2D shows a diagram of a side view of the implementation of FIG. 2C;

FIG. 3A shows a diagram of a perspective view of an implementation of two rectangular airbags connected to a triangular airbag;

FIG. 3B shows a diagram of another perspective view of the implementation of FIG. 3A;

FIG. 4A shows a diagram of a top view of an implementation of a pressure relief valve;

FIG. 4B shows a diagram of a side view of the implementation of FIG. 4A;

FIG. 4C shows a diagram of a perspective view of the implementation of FIG. 4A;

FIG. 4D shows a diagram of a cross section of the implementation of FIG. 4A;

FIG. 5A shows a diagram of a top view of an implementation of a pressure relief valve;

FIG. 5B shows a diagram of a cross section of the implementation of FIG. 5A; and

FIG. 5C shows a diagram of a side view of the implementation of FIG. 5A.

### DETAILED DESCRIPTION

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Industries that require workers to operate with uninhibited mobility from great heights are in need of a fall impact protection system that can break a fall of an object or person while reducing the potential for damage, injury, or death. The invention relates to fall impact protection systems for industries that require workers to operate with uninhibited mobility from great heights. The present invention is related to a modular and interconnectable welded vinyl airbag system for creating a fall impact protection zone. As described further herein, a cap and valve system may be implemented that permits air inflation while precluding depressurization.

Disclosed is an invention to provide that protection with an airtight modular system. The system comprises multiple inflatable airbags, connectors (e.g., connection straps, buckles, etc.), at least one air valve, and at least one air pressure relief valve.

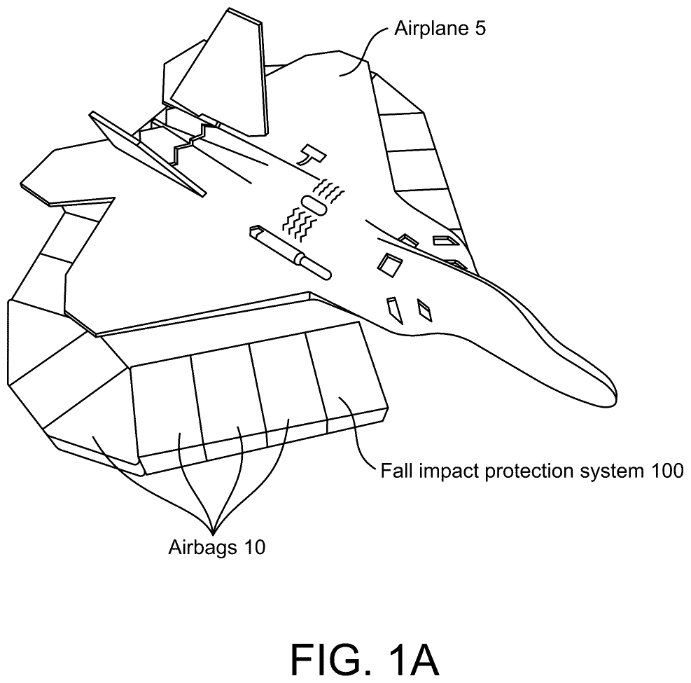

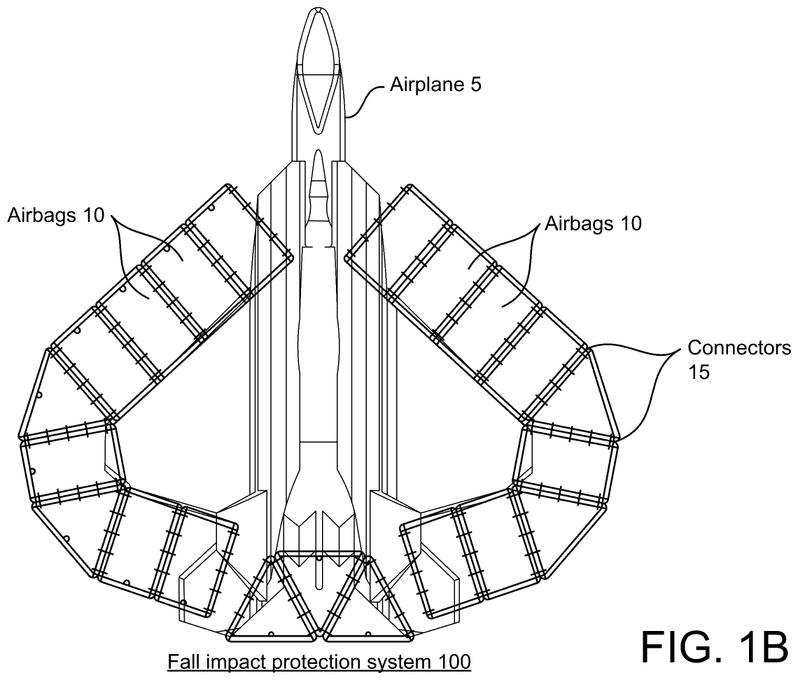

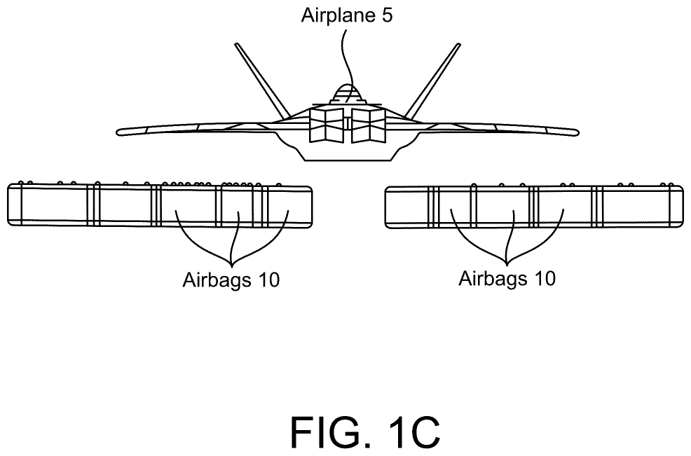

FIG. 1A shows a diagram of a perspective view of an implementation of a fall impact protection system 100 in conjunction with an airplane 5. FIG. 1B shows a diagram of a top view of the implementation of the fall impact protection system 100 in conjunction with the airplane 5 of FIG. 1A. FIG. 1C shows a diagram of a side view (e.g., a rear view, horizontal depiction) of the implementation of the fall impact protection system 100 in conjunction with the airplane 5 of FIG. 1A.

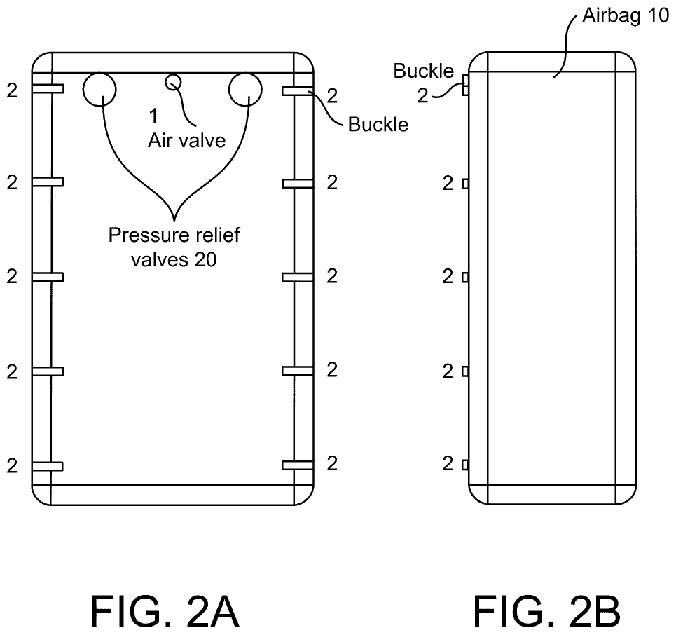

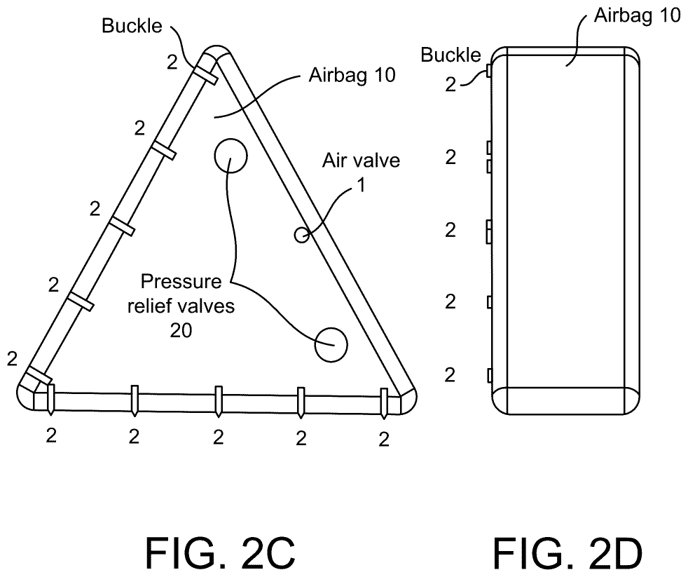

The fall impact protection system 100 comprises a plurality of airbags 10. Each airbag 10 may be connected to one or more other airbags 10 depending on the implementation. The airbags 10 may be connected to one another using connectors 15 such as straps and/or buckles (e.g., the buckles 2 of FIGS. 2A-2D) or any other type(s) of connection device(s) or mechanism(s). Thus, in some implementations, the airbags 10 filled with air may be placed around a structure (such as an airplane or other structure) and connected, for example with buckles 2.

The airbags 10 may be any shape and size depending on the implementation and are not limited to the rectangular and triangular shapes described in more detail herein. More particularly, the inflatable airbags may be different shapes, depending on the implementation. Embodiments may combine triangular airbags of, for example, 8′ length×5′ width×3′ height, with multiple connectors (e.g., connecting buckles 2) and at least one air valve 1 and at least one pressure relief valve 20 (which may also be referred to as an air pressure relief valve). A triangular airbag may be a modular component of dimensions 9′ length for each side of the triangle and 3′ height or depth.

The fall impact protection system 100 may be deployed around and/or underneath areas where people and/or objects may be located and protects the people and/or objects that may fall off the areas and onto the fall impact protection system 100, as described further herein. For example, as shown in FIGS. 1A-1C, the fall impact protection system 100 is deployed underneath and around an airplane 5. In this manner, people or objects (such as workers or tools) that may be working on the airplane 5 or being used to service the airplane 5 are protected from injury or damage if they fall off the airplane 5 onto the fall impact protection system 100. One or more of the airbags 10 will receive the person or object that falls from the airplane 5 and prevent injury or damage to the person or object by actuating as described further herein.

The fall impact protection system 100 is a cost-effective, modular, quick to set-up, no limited target area/sweet spot safety system. A rescue system involving a lanyard designed for fall protection, at certain heights, imposes forces on the anchor that the anchor is not designed for. Embodiments contemplated herein may provide risk reduction for fall hazards of up to 70 feet or higher, depending on an aircraft or structure size, for example. Further, contemplated embodiments allow a fall from height not only of different structure, but for a building, launch aircraft, or other structure having properties that would not allow for the use of lanyards.

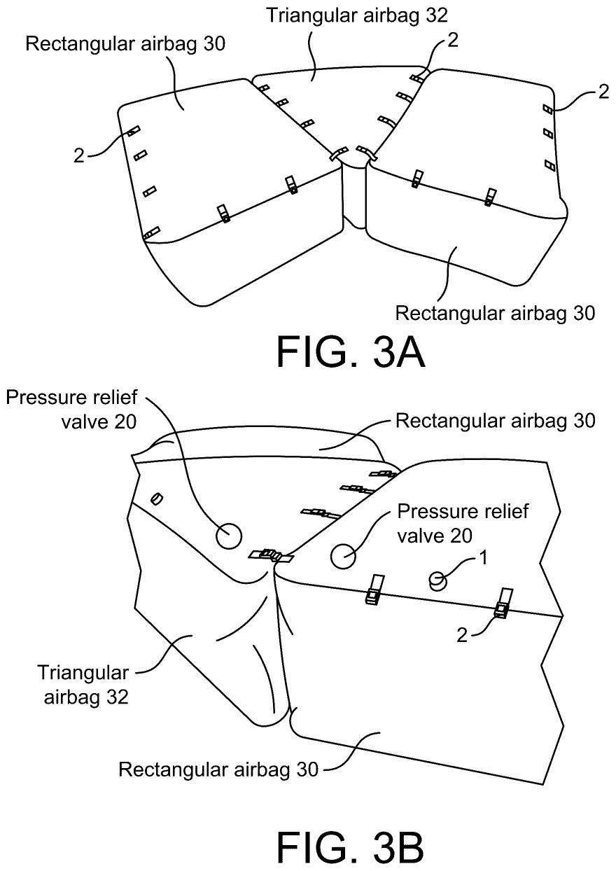

FIG. 2A shows a diagram of a top view of an implementation of a rectangular shaped airbag with an air valve 1, buckles 2, and pressure relief valves 20, and FIG. 2B shows a diagram of a side view of the implementation of FIG. 2A. FIG. 2C shows a diagram of a top view of an implementation of a triangular shaped airbag with an air valve 1, buckles 2, and pressure relief valves 20, and FIG. 2D shows a diagram of a side view of the implementation of FIG. 2C. FIG. 3A shows a diagram of a perspective view of an implementation of two rectangular airbags 30 connected to a triangular airbag 32, and FIG. 3B shows a diagram of another perspective view of the implementation of FIG. 3A.

An embodiment may comprise: a 5.5″ pressure relief valve opening; 3′ high airbags, where the length varies with height of the potential fall distance; and 1.5″ seat belts used for the buckles.

Although the buckles 2 are shown and described as the airbag connectors with respect to FIGS. 2A-2D and FIGS. 3A and 3B, this is not intended to be limiting and it is contemplated that any type of connector(s) may be used to connect airbags 10 together.

The air valve 1 is configured to receive air to fill the associated airbag with air (i.e., inflate the airbag). Embodiments may omit any need of a 110v inflation blower or gasoline powered blowers, which create unnecessary risks to workers. Further, by being air-inflated, embodiments may allow for more compact, smaller storage space when the system is not being used.

The air valves 1 do not require continuous air flow to pressurize the airbag(s) 10. More particularly, embodiments do not require a continuously operating pneumatic device, which would otherwise place significant energy, ventilation, and other operational demands on an operator while increasing setup and breakdown times. Additionally, embodiments do not expose workers to risks of power interruption leading to depressurization and the potential for exhaust fumes to reach dangerous levels due to loss of ventilation.

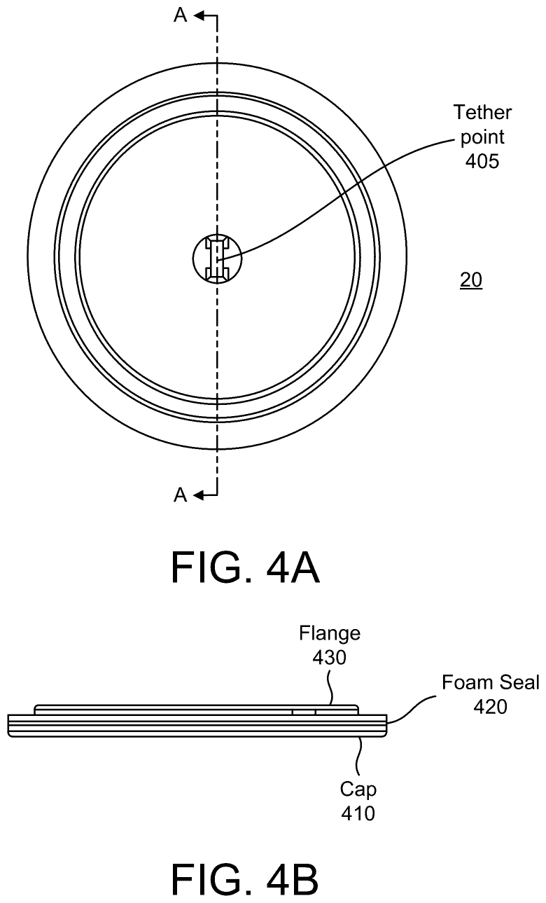

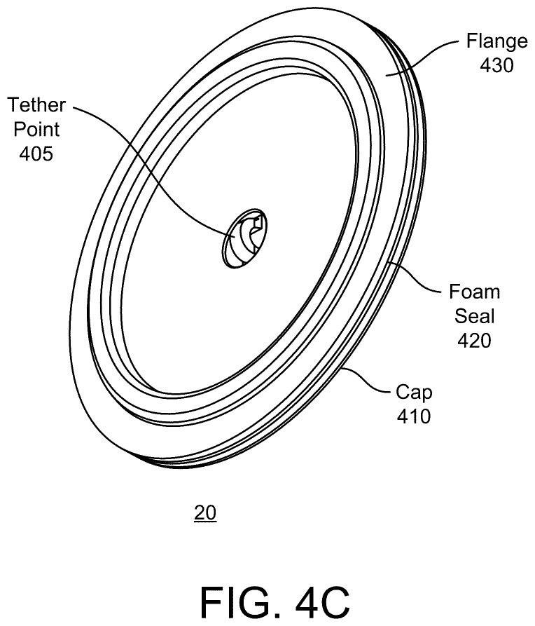

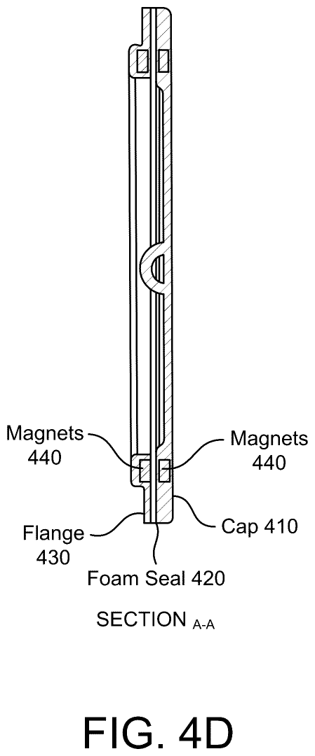

FIG. 4A shows a diagram of a top view of an implementation of a pressure relief valve 20. FIG. 4B shows a diagram of a side view of the implementation of FIG. 4A. FIG. 4C shows a diagram of a perspective view of the implementation of FIG. 4A. FIG. 4D shows a diagram of a cross section of the implementation of FIG. 4A.

In an implementation, the pressure relief valve 20 is a magnet release valve. Referring to FIGS. 4A-4D, the pressure relief valve 20 comprises a cap 410, a flange gasket comprising a foam seal 420, a flange 430, and magnets 440. Additionally, the pressure relief valve 20 comprises a tether point 405, along with the cap 410, a foam seal 420, and a flange 430. The tether point 405 may be used to receive a string or rope or other tethering device to retain the pressure relief valve 20 to the airbag upon deployment of the pressure relief valve 20. In this manner, when the airbag receives impact and the pressure relief valve 20 depressurizes the airbag (e.g., by coming out of the airbag to release air from the airbag), the pressure relief valve 20 does not haphazardly come away from the airbag but instead is safely maintained connected to the airbag using a string or rope etc. that is attached between the airbag and the tether point 405.

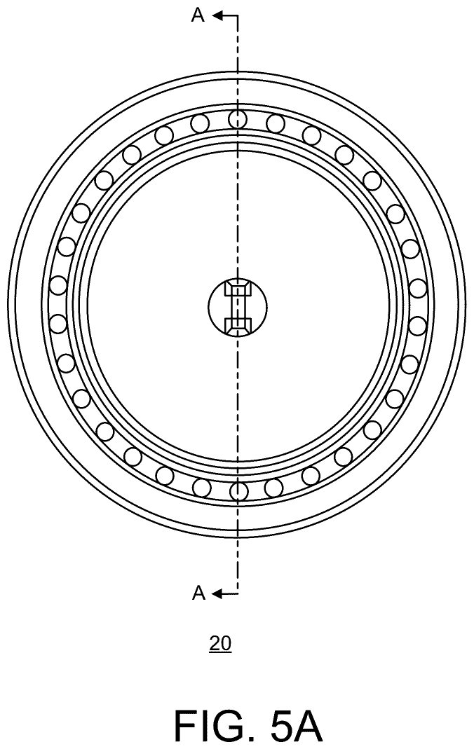

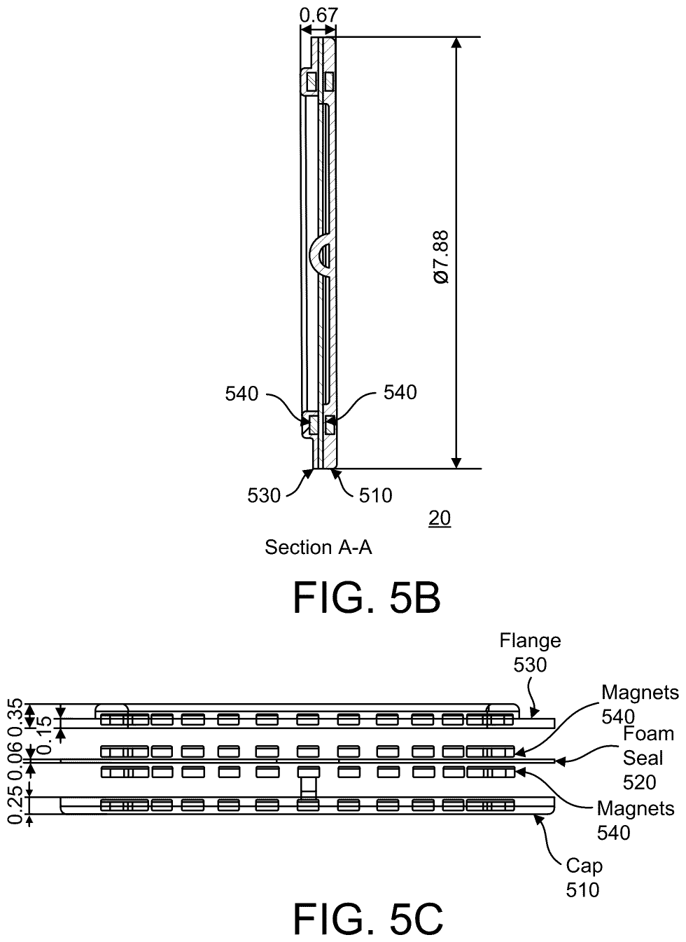

FIG. 5A shows a diagram of a top view of an implementation of a pressure relief valve 20. FIG. 5B shows a diagram of a cross section of the implementation of FIG. 5A. FIG. 5C shows a diagram of a side view of the implementation of FIG. 5A. FIGS. 4A-4D show solid views of a pressure relief valve 20, and FIGS. 5A-5C show cutaway views of a pressure relief valve 20. Referring to FIGS. 5A-5C, the pressure relief valve 20 (similarly to FIGS. 4A-4D) comprises a cap 510, a flange gasket 520, a flange 530, and magnets 540.

Each pressure relief valve 20 is configured to depressurize its associated airbag 10, upon the airbag 10 receiving impact (e.g., from a fall from the airplane or other structure), at a rate that safely decelerates the person or object. Implementations of a pressure relief valve 20 comprise a valve component or a pressure relief valve cap component.

Upon kinetic pressure received by the airbag 10, a force will push the air against the pressure relief valve 20, forcing the valve 20 to extend out, to the exterior of the airbag 10, breaking the seal, releasing air pressure and decelerating any kinetic force, for example from a worker's fall.

In an implementation, the pressure relief valve 20 comprises a cap (e.g., the cap 410 or 510) and a flange (e.g., the flange 430 or 530) made from thermoplastic polyurethane, with a foam seal (e.g., the foam seal 420 or 520) layer. The cap and the flange have magnets (e.g., the magnets 440 or 540) encapsulated within each part to maintain seal prior to a fall event creating kinetic force to release pressure. Each cap is secured to an airbag (e.g., a bladder of an airbag 10) internally with a bungee system to ensure proper seating when inflated and secure the cap to the bladder when actuated by a fall event. In the event of a fall, the kinetic force created pushes the cap to release from the magnetic seal of the flange, releasing air at a rate designed to slow the fall of a person or item. Each cap and flange system is designed to be reset after an event.

Embodiments are airtight (the airbags) and, after inflation, a blower system is not required. Embodiments are constructed through a heat welding process to produce a solidly constructed, airtight system, made to release air pressure upon impact at the valves and at no other location. The trigger for the pressure relief valve to actuate is the body's (or other object's) impact on the airbag.

The fall protection system is configured to be inflated without the need of a continuous blower system. In an implementation, each bladder has a fill nozzle and cap that seals the bladder to maintain a consistent pressure without the need of air flow. The bladders are comprised of a PVC vinyl and constructed through a heat welding process, which is different than systems that are sewn with needles and thread. Sewing creates micro-punctures creating the need for a continuous air flow to maintain inflation. With heat welding, all seams are airtight and welded together using hot air (e.g., 1230° F. hot air), essentially melting the sheets of vinyl together while the material is moved through a pressurized roller system, avoiding those micro-punctures, and therefore not needing continuous air to maintain integrity.

A specific, one-size-fits-all PSI is not required for use of the system 100. Inflation levels on the airbags 10 in use are relatively low, which allows for the pressure to be created and released upon impact. The number of pressure relief valves 20 used may vary based on the rating/height of the fall requirements.

In an implementation, a fall impact protection system is provided. The system includes: a plurality of airbags buckled together to create a fall impact protection zone, wherein each of the airbags is inflatable, and a trigger mechanism configured to release air pressure from at least one of the airbags when the at least one of the airbags is inflated and decelerate any kinetic force, responsive to an impact on the at least one of the airbags when inflated. The at least one of the airbags, when inflated, is configured to maintain pressurization prior to the impact without use of a continuous blower system.

Implementations may include some or all of the following features. The at least one of the airbags comprises two pressure relief valves, and wherein the trigger mechanism is configured to actuate upon the impact, and wherein the actuation of the trigger mechanism is further configured to cause at least one of the pressure relief valves to release air from the at least one of the airbags. Each of the airbags is sealed and the airbags are configured to maintain pressurization without the use of a continuous air source. The airbags comprise vinyl. The trigger mechanism comprises magnets.

In an implementation, a fall impact protection system is provided. The system includes: a plurality of bladders (each of which may be an air bag and/or comprised within an airbag), a plurality of valves, and a plurality of connectors between the bladders. Each of the valves comprises a fastener, a resilience device for storing elastic potential energy, and a valve plate that is configured to extrude in response to a predetermined amount of kinetic force to decelerate an impact. The at least one of the bladders, when inflated, is configured to maintain pressurization prior to the impact without use of a continuous blower system.

Implementations may include some or all of the following features. Each of the bladders comprises a flexible material that expands to a substantially fixed volume, and each of the bladders is configured to receive a predetermined volume of pressurized gas. The system further comprises a removable power source configured to be removed after a pressurization of the bladders. The system is configured to sense an acceleration exceeding a predetermined threshold. The bladders comprise at least two pressure relief valves. The system is configured as a secondary fall impact protection system. At least one of the valves is located towards a corner of at least one of the bladders. Each of the bladders is comprised within an associated airbag, the system further comprising a trigger mechanism configured to release air pressure from at least one of the airbags when the at least one of the airbags is inflated and decelerate any kinetic force, responsive to an impact on the at least one of the airbags when inflated. The at least one of the airbags, when inflated, is configured to maintain pressurization prior to the impact without use of a continuous blower system. The trigger mechanism comprises magnets.

In an implementation, a pressure relief valve is provided. The pressure relief valve comprises a cap, a flange gasket, a flange, and a plurality of magnets. The pressure relief valve is configured to release air pressure from an airbag to decelerate any kinetic force, responsive to an impact on the airbag.

Implementations may include some or all of the following features. The cap and the flange comprise thermoplastic polyurethane with a foam seal layer. The cap and the flange encapsulate the plurality of magnets to maintain seal prior to a fall event creating kinetic force to release pressure. The cap is secured to a bladder of the airbag internally with a bungee system to ensure proper seating when inflated and secure the cap to the bladder when actuated by a fall event. In the event of a fall, the kinetic force created to the cap is used to release from a magnetic seal of the flange, releasing air at a rate designed to slow the fall of a person or item. The pressure relief valve is configured such that the airbag maintains inflation with the need of a continuous blower system. As used herein, the singular form “a,” “an,” and “the” include plural references unless the context clearly dictates otherwise. As used herein, the terms “can,” “may,” “optionally,” “can optionally,” and “may optionally” are used interchangeably and are meant to include cases in which the condition occurs as well as cases in which the condition does not occur.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A fall impact protection system comprising:
a plurality of airbags buckled together to create a fall impact protection zone, wherein each of the airbags is inflatable, and
a trigger mechanism configured to release air pressure from at least one of the airbags when the at least one of the airbags is inflated and decelerate any kinetic force, responsive to an impact on the at least one of the airbags when inflated,
wherein the at least one of the airbags, when inflated, is configured to maintain pressurization prior to the impact without use of a continuous blower system.

2. The system of claim 1, wherein the at least one of the airbags comprises two pressure relief valves, and wherein the trigger mechanism is configured to actuate upon the impact, and wherein the actuation of the trigger mechanism is further configured to cause at least one of the pressure relief valves to release air from the at least one of the airbags.

3. The system of claim 1, wherein each of the airbags is sealed and the airbags are configured to maintain pressurization without the use of a continuous air source.

4. The system of claim 1, wherein the airbags comprise vinyl.

5. The system of claim 1, wherein the trigger mechanism comprises magnets.

6. A fall impact protection system comprising:
a plurality of bladders,
a plurality of valves, and
a plurality of connectors between the bladders,
wherein each of the valves comprises a fastener, a resilience device for storing elastic potential energy, and a valve plate that is configured to extrude in response to a predetermined amount of kinetic force to decelerate an impact, and
wherein the at least one of the bladders, when inflated, is configured to maintain pressurization prior to the impact without use of a continuous blower system.

7. The system of claim 6, wherein each of the bladders comprises a flexible material that expands to a substantially fixed volume, and wherein each of the bladders is configured to receive a predetermined volume of pressurized gas.

8. The system of claim 6, further comprising a removable power source configured to be removed after a pressurization of the bladders.

9. The system of claim 6, wherein the system is configured to sense an acceleration exceeding a predetermined threshold.

10. The system of claim 6, wherein the plurality of bladders comprises at least two pressure relief valves.

11. The system of claim 6, wherein the system is configured as a secondary fall impact protection system.

12. The system of claim 6, wherein at least one of the valves is located towards a corner of at least one of the bladders.

13. The system of claim 6, wherein each of the bladders is comprised within an associated airbag, further comprising a trigger mechanism configured to release air pressure from at least one of the airbags when the at least one of the airbags is inflated and decelerate any kinetic force, responsive to an impact on the at least one of the airbags when inflated,
wherein the at least one of the airbags, when inflated, is configured to maintain pressurization prior to the impact without use of a continuous blower system.

14. The system of claim 13, wherein the trigger mechanism comprises magnets.

15. A pressure relief valve comprising:
a cap;
a flange gasket;
a flange; and
a plurality of magnets,
wherein the pressure relief valve is configured to release air pressure from an airbag to decelerate any kinetic force, responsive to an impact on the airbag.

16. The pressure relief valve of claim 15, wherein the cap and the flange comprise thermoplastic polyurethane with a foam seal layer.

17. The pressure relief valve of claim 15, wherein the cap and the flange encapsulate the plurality of magnets to maintain seal prior to a fall event creating kinetic force to release pressure.

18. The pressure relief valve of claim 15, wherein the cap is secured to a bladder of the airbag internally with a bungee system to ensure proper seating when inflated and secure the cap to the bladder when actuated by a fall event.

19. The pressure relief valve of claim 15, configured to, in the event of a fall, use the kinetic force created to the cap to release from a magnetic seal of the flange, releasing air at a rate designed to slow the fall of a person or item.

20. The pressure relief valve of claim 15, configured such that the airbag maintains inflation with the need of a continuous blower system.
